(19) United States
(12) Patent Application Publication
(10) Pub. No.: US 2015/0215744 A1
(43) Pub. Date: Jul. 30, 2015

(54) SYSTEM AND METHOD FOR INDOOR POSITIONING, NAVIGATION AND LOCATION SPECIFIC SERVICES

(71) Applicant: GENERAL ELECTRIC COMPANY, Schenectady, NY (US)

(72) Inventors: András KUTI, Budapest (HU); László BALÁZS, Budapest (HU); Zoltán TÓTH, Budapest (HU)

(73) Assignee: GENERAL ELECTRIC COMPANY, Schenectady, NY (US)

(21) Appl. No.: 14/168,774

(22) Filed: Jan. 30, 2014

(51) Int. Cl. H04W 4/04

(52) U.S. Cl. CPC H04W 4/04

(57) ABSTRACT

A system including a luminaire lens including a surface having a coded positional data pattern, a mobile communication device including a camera and a display screen, a database having data records representing a floor plan of a building or structure, the mobile communication device in communication with the database, and a mobile communication device application, the application configured to decode the coded positional data pattern and to locate the decoded positional data on the floor plan, wherein the decoded positional data is displayed on the display screen. A method includes providing a luminaire lens having a coded positional data pattern, decoding the positional data, locating the decoded positional data on the floor plan, and displaying the decoded positional data on a display screen. A non-transitory medium having executable instructions is also described.

### BACKGROUND

Mobile communication devices (e.g., mobile phones, smartphones, digital assistants, handheld computers, tablets, pads, etc.) can provide navigation information to its user. As an example, mobile devices with global positioning system (GPS) capabilities can determine the device's location and provide directions to a specified destination. Accurate GPS positioning typically relies on obtaining unobstructed, line-of-sight signals from geosynchronous GPS satellites. The requirement for line-of-sight signals is problematic in determining positioning and navigation in buildings, large structures, and underground locations where GPS satellite signals are obstructed.

Conventional solutions to providing position and navigation information within these structures include providing beacons at known locations within the structure. These beacons can be broadcast by Bluetooth® transmitters (Bluetooth Sig, Inc., Kirkland, Wash.), and include location information which corresponds to the beacon transmitter's position within the structure.

An alternate approach to indoor positioning includes modulating the light output of LED lamps installed throughout the structure. The LED light can be modulated at a fast rate that is imperceptible to the human eye. This modulation can be detected by suitably configured cameras. The modulation can include positioning data of the LED lamp. A digital camera on a handheld device in conjunction with an application can discern the modulated data. The modulation requires the placement of a microchip controller at each LED lamp undergoing modulation. The microchip, in conjunction with software, controls the fast rate modulation.

The position of the mobile device can be determined from finding the transmitted positional information in an indoor map of the structure. This map can be downloaded to the mobile device, or the mobile device can use a local area network to access a database containing the indoor map.

Conventional indoor location services can include placement of a beacon transmitter and/or a microchip throughout the structure. These devices can add extra expense (per unit costs, additional wiring for power and control, etc.), particularly in large structures.

### BRIEF DESCRIPTION OF THE. DRAWINGS

FIG. 1 depicts system 100 for providing location information in accordance with some embodiments;

FIG. 2 depicts a block diagram of a mobile communication device in accordance with some embodiments; and

FIG. 3 depicts a process in accordance with some embodiment.

### DETAILED DESCRIPTION

Systems and method in accordance with embodiments provide accurate position location information from luminaires within a building or structure. These luminaires can include a diffuser, lens, or cover (collectively herein “lens”) which contains coded location data. The coded location data can be obtained by a mobile communication device's camera in conjunction with an application to decode the location data. In one implementation, the front-facing lens of the mobile communication device's camera can be used so that a user can obtain an image of the luminaire's lens, and then view their location on the structure's floor plan displayed on the mobile communication device's display screen.

In accordance with embodiments, coded location data within the structure can be obtained by interpreting the coded location data received from luminaire lenses located throughout the structure. The coded location data can be used to identify the corresponding position on a building floor plan displayed on the mobile communication device.

In accordance with embodiments, luminaire lens surfaces are encoded with a pattern. This pattern can be visible for a standard camera. In other implementations, the lens can be transparent for visible light but include a pattern and/or image impenetrable or otherwise detectable for infrared radiation, where the camera can detect in the infrared frequency spectrum so that this infrared pattern and/or image is detected. For example, the camera may be capable of distinguishing a pattern that appears in the near-IR frequency range.

There are several technologies to modulate the lens surface into a code. For example, different areas of the lens can be covered with a masking layer to reduce the visible light transmission, thus arranging a visible pattern on the lens surface; a pattern can be etched or incused into the lens during manufacture; LEDs can be placed within the luminaire so that patterns of distinct brightness are detectable on the lens surface. In accordance with embodiments, the coded location data can be a binary code (e.g., a bar code, a two-dimensional bar code, etc.), pictures, brand logos, and/or other unique patterns, shapes, signs, etc.

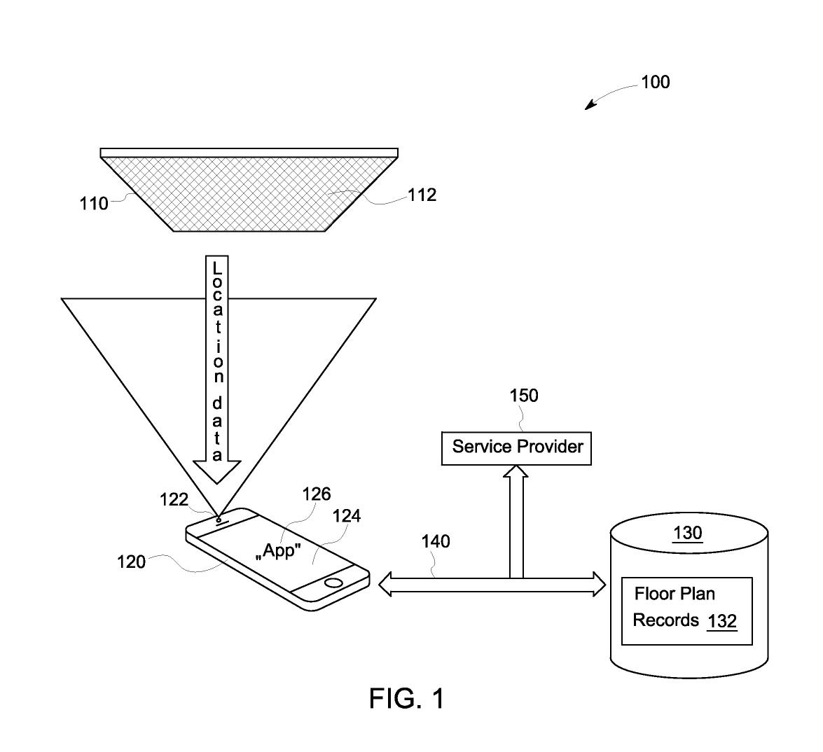

FIG. 1 depicts system 100 for providing location information in accordance with some embodiments. System 100 includes luminaire lens 110 which includes a surface having coded positional data 112. The coded positional data can be a patterned masking layer, a binary code, or other pattern and/or image which can be unique to each luminaire lens, where the coded positional data's uniqueness is an indication of a particular luminaires location within the building structure.

Mobile communication device 120 (e.g., mobile phones, smartphones, digital assistants, handheld computers, tablets, pads, etc.) includes a camera and lens 122, which can detect the coded positional data of the luminaire. The positional data can be encoded in the visible light spectrum, or in other implementations encoded in infra-red spectrum. Mobile communication device 120 also includes display 124 and application 126. The display can be used in conjunction with camera and lens 122 to aid in focusing luminaire lens 110 while obtaining the image. Also, the structure's floor plan can be depicted on display 124 to indicate positional location within the structure.

In accordance with some embodiments, mobile communication device 120 can be in communication with database 130 via electronic communication network 140. Database 130 can include floor plan records 132 of a building and/or a structure, which can be downloaded to the mobile communication device for display. Electronic communication network 140 can be can comprise or can be part of a private intranet protocol (IP) network, the Internet, an integrated services digital network (ISDN), a public or private data network, a local area network (LAN), a metropolitan area network (MAN), a wide area network (WAN), a wireline or wireless network (e.g., 3G, 4G, WiFi, etc.), a local, regional, or global communication network, a virtual private network, an enterprise intranet, any combination of the preceding and/or any other suitable electronic communication network. It should be recognized that techniques and systems disclosed herein are not limited by the nature of network 140.

In accordance with some embodiments, system 100 can include service provider 150 in communication across electronic communication network 140 with system 100.

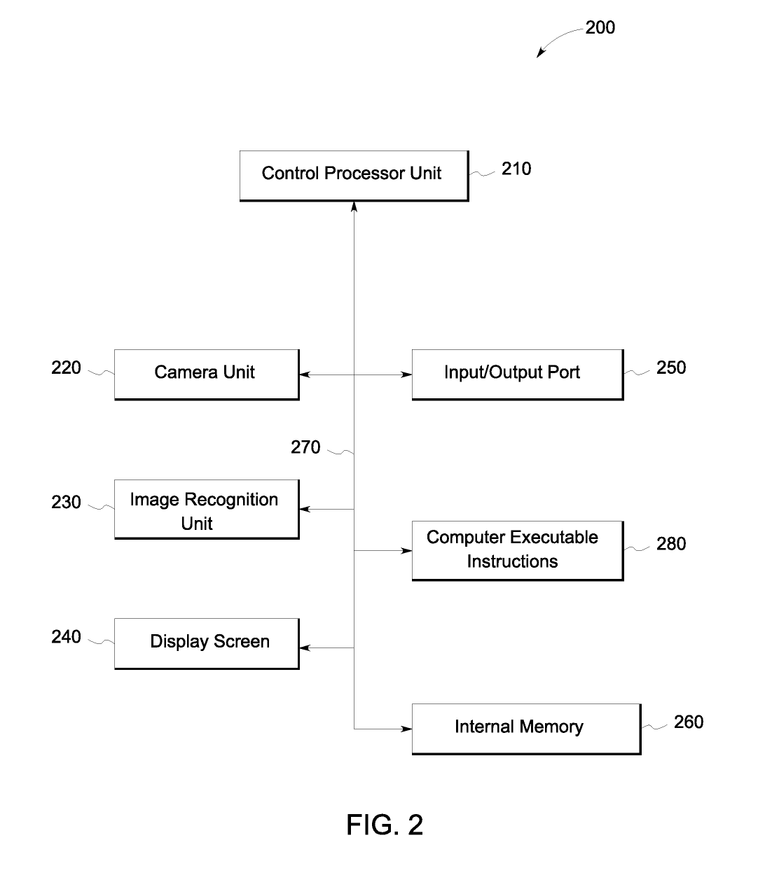

FIG. 2 depicts a block diagram of mobile communication device 200 for discerning location encoded data on a luminaire lens in accordance with some embodiments. Mobile communication device 200 includes control processor unit 210 which is in communication with other components of the mobile communication device across internal communication bus 270. The control processor is configured to execute executable instructions 280, which causes the mobile communication device to perform the methods and processes described herein.

Mobile communication device 200 includes camera unit 220, which includes at least one camera lens. In accordance with some implementations, the mobile communication device can include a lens on two opposing surfaces (e.g., a forward lens and a front facing lens). In accordance with embodiments, camera unit 220 can include both visible and infra-red capabilities. The camera unit can obtain an image that is stored in internal memory 260.

Image recognition unit 230 accesses images obtained by the camera unit and analyzes these images to determine if a pattern is encoded in the image. Both images obtained from the camera unit and patterns discerned by the image recognition unit can be displayed on display screen 240.

Mobile communication device 200 can be in communication with external devices via input/output port 250. For instance, the I/O port can be used to obtain structure floor plans from an external database. The floor plan can include map(s) of the building and the patterns of location encoded luminaire lenses along with their position within the structure.

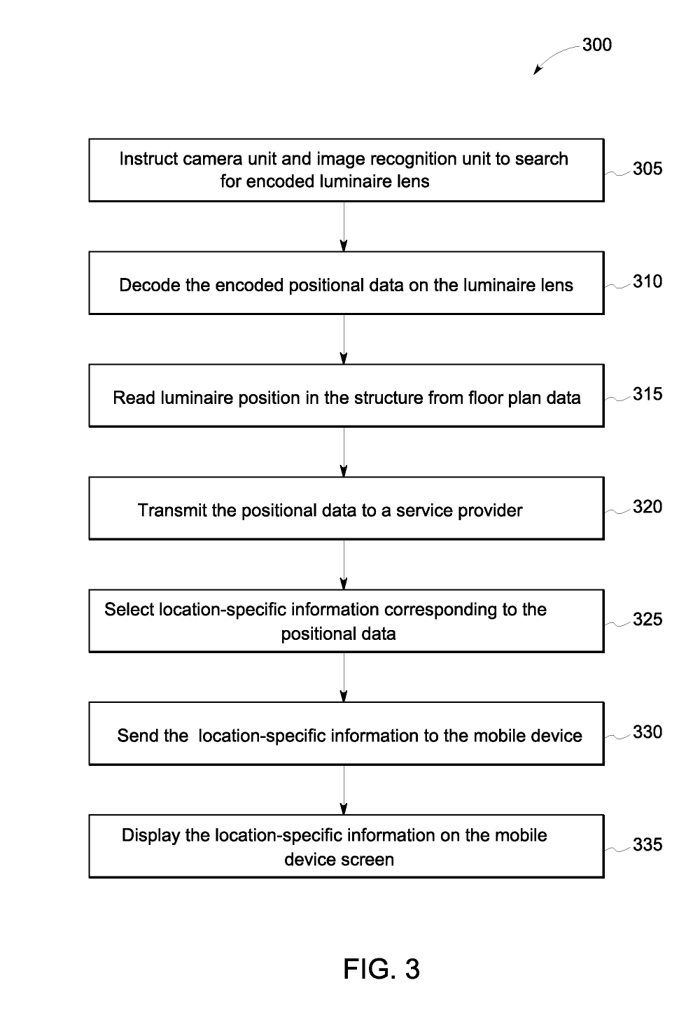

FIG. 3 depict process 300 for discerning positional information from a location encoded luminaire lens in accordance with some embodiments. Process 300 can be downloaded as an application to the mobile communication device. In accordance with some embodiments, a structure's floor plan can be downloaded. The floor plan can include the positional locations of the encoded luminaire lens(es).

In accordance with some implementations, the application can be launched on the mobile communication device and instruct, step 305, the camera unit and image recognition unit to conduct a search for encoded lenses until a first encoded lens is obtained. This search can be ongoing (e.g., continuously, or at intervals) until the first encoded lens is obtained.

After obtaining a first encoded luminaire lens, the encoded location data can be decoded, step 310. At step 315, the luminaire's position can be located on the structure's floor plan data. In accordance with some implementations, this positional information can be transmitted, step 320, to a service provider through an electronic communication network. In accordance with some implementations, the service provider is remotely located and in communication with the mobile communication device across electronic communication network 140.

The service provider can use the positional information to select, step 325, location-specific information that corresponds to the positional data. The location-specific information is sent, step 330, by the service provider to the mobile communication device, which displays, step 335, the location-specific information on its display screen.

In accordance with some embodiments, the location-specific information can be aid users in navigating their way through the structure. For instance, and by way of example, to stores in a mall; offices in an office building; wards of a hospital; platforms in a railway station; and paths to specific destinations in a large structure. Additionally, the location-specific information can identify on the floor plan displayed on the mobile communication device screen the location of ATMs, restrooms, elevators, stairs, etc.

Service providers can send location-specific information to the mobile communication device that includes special offers at commercial facilities (stores, professional offices, restaurants, etc.) located in the vicinity of the mobile communication device.

Further, the positional information sent to the service provider can be used to build a route within the structure traversed by the mobile communication device's user. For example, a department store could want information on which departments are visited by the user. The information could include time duration spent at, or near, the particular location, thus, indicating the interest of the user.

In accordance with some embodiments, during an emergency (e.g., a fire, police action, etc.) the backlight of the mobile communication device screen can be maximized to provide illumination to assist the user in navigating to the exit, or meeting place.

In accordance with an embodiment, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for discerning positional information from location coded patterns on a luminaire lens.

The computer-readable medium may be a non-transitory computer-readable media including all forms and types of memory and all computer-readable media except for a transitory, propagating signal. In one implementation, the non-volatile memory or computer-readable medium may be external memory. In such an implementation, the computer program application can be copied from the external memory to internal memory of the mobile communication device.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A system comprising:
a luminaire lens including a surface having a coded positional data pattern;
a mobile communication device including a camera and a display screen;
a database having data records representing a floor plan of a building or structure, the mobile communication device in communication with the database; and
a mobile communication device application, the application configured to decode the coded positional data pattern and to locate the decoded positional data on the floor plan, wherein the decoded positional data is displayed on the display screen.

2. The system of claim 1 including a plurality of luminaire lenses, wherein the coded positional data pattern is unique to each respective one of the plurality of luminaire lenses.

3. The system of claim 1, wherein the coded positional data pattern is one of a masking layer, a binary code, and an image.

4. The system of claim 1, wherein the coded positional data is encoded in an infrared spectrum frequency.

5. The system of claim 4, wherein the camera is configured to detect in the infrared frequency.

6. The system of claim 1, including:
a service provider in communication with the database and the mobile communication device;
the service provider configured to select location-specific information corresponding to the decoded positional data; and
the service provider configured to send the location-specific information to the mobile communication device.

7. A method comprising:
providing a luminaire lens including a surface having a coded positional data pattern;
accessing a database having data records representing a floor plan of a building or structure;
furnishing a mobile communication device application configured to decode the coded positional data pattern and to locate the decoded positional data on the floor plan; and
displaying the decoded positional data on a display screen of a mobile communication device.

8. The method of claim 7, including the steps of:
transmitting the decoded positional data to a service provider configured to select location-specific information corresponding to the decoded positional data; and
sending the location-specific information to the mobile communication device application for display on the display screen.

9. The method of claim 7, including the step of providing a plurality of luminaire lenses, wherein the coded positional data pattern is unique to each respective one of the plurality of luminaire lenses.

10. The method of claim 7, including the step of covering at least a portion of the luminaire lens with at least one of a masking layer, a binary code, and an image.

11. The method of claim 7, including the step of encoding the coded positional data in an infrared spectrum frequency.

12. A non-transitory computer readable medium having stored thereon instructions which when executed by a processor cause the processor to perform a method comprising:
accessing a database having data records representing a floor plan of a building or structure;
furnishing a mobile communication device application configured to decode the coded positional data pattern and to locate the decoded positional data on the floor plan; and
displaying the decoded positional data on a display screen of a mobile communication device.

13. The non-transitory computer readable medium of claim 12, further including executable instructions to cause a processor to perform the steps of:
transmitting the decoded positional data to a service provider configured to select location-specific information corresponding to the decoded positional data; and
sending the location-specific information to the mobile communication device application for display on the display screen.

14. The non-transitory computer readable medium of claim 12, further including executable instructions to cause a processor to perform the step of covering at least a portion of the luminaire lens with at least one of a masking layer, a binary code, and an image.

15. The non-transitory computer readable medium of claim 12, further including executable instructions to cause a processor to perform the step of encoding the coded positional data in an infrared spectrum frequency.

16. A luminaire lens including a surface having a coded positional data pattern.

17. The lens of claim 16, wherein the coded positional data pattern is one of a masking layer, a binary code, and an image.

18. The lens of claim 16, wherein the coded positional data is encoded in an infrared spectrum frequency.
